(19) United States
(12) Patent Application Publication
(10) Pub. No.: US 2025/0141865 A1
(43) Pub. Date: May 1, 2025

(54) MULTI-APPLICATION REGISTRATION AND VERIFICATION

(71) Applicant: WhatsApp LLC, Menlo Park, CA (US)

(72) Inventors: Parth Shah, Dublin, CA (US); Zhixin Feng, San Jose, CA (US); Yujing Zhong, San Jose, CA (US)

(21) Appl. No.: 18/494,678

(22) Filed: Oct. 25, 2023

(51) Int. Cl. H04L 9/40

(52) U.S. Cl. CPC H04L 63/0838; H04L 63/0853

(57) ABSTRACT

Methods, systems, and storage media for multi-application registration and verification are disclosed. Exemplary implementations may: identify a gateway application programming interface (API) on a client device, wherein the gateway API is configured to communicate with a plurality of auxiliary APIs associated with the client device; register the client device via the gateway API; verify registration of the client device; and create at least one verifier configured to communicate between the plurality of auxiliary APIs associated with the client device; and accessing the plurality of auxiliary APIs associated with the client device via the at least one verifier.

### TECHNICAL FIELD

The present disclosure generally relates to registration and verification on user applications (e.g., for social media platforms, instant messaging platforms, etc.), and more particularly to multi-application registration and verification.

### BACKGROUND

Phone number verification is a commonly used feature in user applications (apps) that use short message service (SMS) one-time password (OTP) authentication. The feature may involve sending a unique code to the user's phone number, which they then enter into the application to confirm their identity. The verification process may occur during the registration process, or when the user attempts to perform a high-risk action within the application. The SMS OTP may also be accompanied by additional security measures, such as biometric authentication or security questions, to provide a multi-factor authentication process. Some applications may also limit the number of attempts a user can make to enter the correct code before temporarily blocking the account. Phone number verification with SMS OTP can be an effective way to enhance the security of user applications and protect user data. However, the conventional methods of phone number verification using SMS OTP codes are costly and inefficient.

### BRIEF SUMMARY

The subject disclosure provides for systems and methods for registration and verification on user applications. A user is allowed to register for multiple user applications without having to verify their phone number through an SMS OTP code. For example, the user can register for the multiple user applications using a query and encryption protocol exchange between one of the user applications, its web client, and its application server.

One aspect of the present disclosure relates to a method for multi-application registration and verification. The method may include identifying a gateway application programming interface (API) on a client device, wherein the gateway API is configured to communicate with a plurality of auxiliary APIs associated with the client device. The method may include registering the client device via the gateway API. The method may include verifying registration of the client device. The method may include generating at least one verifier configured to communicate between the plurality of auxiliary APIs associated with the client device. The method may include accessing the plurality of auxiliary APIs associated with the client device via the at least one verifier.

Another aspect of the present disclosure relates to a system configured for multi-application registration and verification. The system may include one or more hardware processors configured by machine-readable instructions. The processor(s) may be configured to identify a gateway API on a client device, wherein the gateway API is configured to communicate with a plurality of auxiliary APIs associated with the client device. The processor(s) may be configured to register the client device via the gateway API. The processor(s) may be configured to verify registration of the client device. The processor(s) may be configured to determine a preexisting verifier for the client device. The processor(s) may be configured to determine that the preexisting verifier has exceeded a registration threshold. The processor(s) may be configured to create at least one verifier configured to communicate between the plurality of auxiliary APIs.

Yet another aspect of the present disclosure relates to a non-transient computer-readable storage medium having instructions embodied thereon, the instructions being executable by one or more processors to perform a method for multi-application registration and verification. The method may include identifying a gateway API on a client device, wherein the gateway API is configured to communicate with a plurality of auxiliary APIs associated with the client device. The method may include registering the client device via the gateway API. The method may include verifying registration of the client device. Verifying registration may include verifying a user's identity via biometric authentication. The method may include determining a preexisting verifier for the user device. The method may include determining that the preexisting verifier has exceeded a registration threshold. The method may include creating at least one verifier configured to communicate between the plurality of auxiliary APIs. The at least one verifier may be selected based on a user's consent for multi-app auto-confirmation.

Still another aspect of the present disclosure relates to a system configured for multi-application registration and verification. The system may include means for identifying a gateway API on a client device. The system may include means for registering the client device via the gateway API. The system may include means for verifying registration of the client device. The system may include means for creating at least one verifier configured to communicate between a plurality of APIs.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIGS. 2A and 2B illustrate an example flow diagram for registration through user applications, in accordance with one or more implementations.

FIG. 3 illustrates an example flow diagram for verification through user applications, in accordance with one or more implementations.

FIG. 4 illustrates an example view of a user application during verification, in accordance with one or more implementations.

FIG. 5 illustrate example views of the user application during privacy setting updates, in accordance with one or more implementations.

FIG. 6 illustrates a system configured for registration and verification on user applications, in accordance with one or more implementations.

FIG. 7 illustrates an example flow diagram for registration and verification on user applications, according to certain aspects of the disclosure.

FIG. 8 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

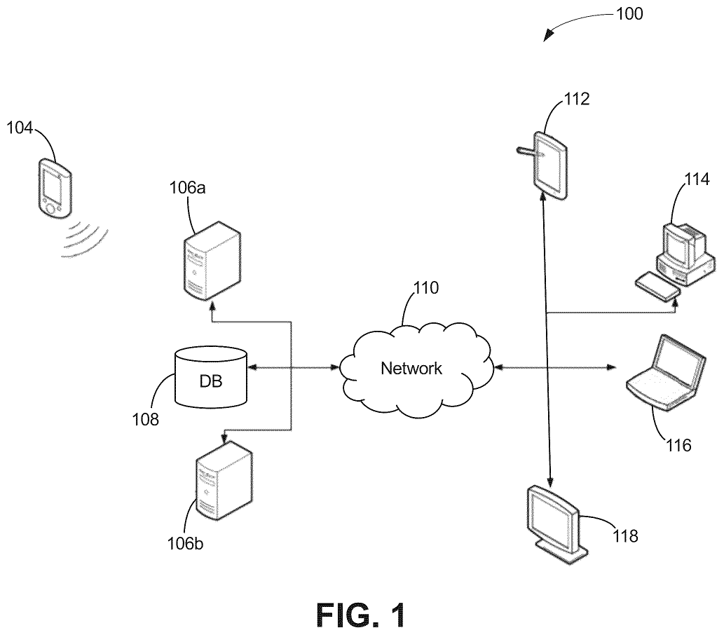

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices. The server computing devices 106a-106b may be configured to show (e.g., make encrypted content visible) content to one or more of the client computing devices for those client computing devices that presented a correct public key. As an example, the server computing devices 106a-106b can include a database (e.g., database 108) that tracks which users of the client computing devices have granted access to their encrypted content (e.g., encrypted by corresponding privately held private keys) to other client users.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing device 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations. The database 108 can store data indicative of keys or access granted by a given user to other users of the given user's encrypted content and/or shared social media content that can be subscribed to by other users. The database 108 may also be used to facilitate key rotation in a one-to-many encryption architecture by causing issue of new keys when a copy of a shared key becomes comprised, for example.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network. In some implementations, the server computing devices 106a-106b can be used as part of a social network such as implemented via the network 110. The social network can host content and protect access to the content, such as via the database 108, although the server computing devices 106a-106b of the social network do not have access to private keys and can be remote/separate from the application(s) that perform key generation and content encryption. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc.

Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea. The social networking system can enable a user to enter and display information related to the users' interests, age/date of birth, location (e.g., longitude/latitude, country, region, city, etc.), education information, life stage, relationship status, name, a model of devices typically used, languages identified as ones the user is familiar with, occupation, contact information, or other demographic or biographical information in the users' profile. Any such information can be represented, in various implementations, by a node or edge between nodes in the social graph.

The social networking system can enable a user to upload or create pictures, videos, documents, songs, or other content items, and can enable a user to create and schedule events. Content items can be represented, in various implementations, by a node or edge between nodes in the social graph. The social networking system can enable a user to perform uploads or create content items, interact with content items or other users, express an interest or opinion, or perform other actions. The social networking system can provide various means to interact with non-user objects within the social networking system. Actions can be represented, in various implementations, by a node or edge between nodes in the social graph. For example, a user can form or join groups, or become a fan of a page or entity within the social networking system. In addition, the user can create, download, view, upload, link to, tag, edit, or play a social networking system object. The user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, the user can use location detection functionality (such as a GPS receiver on a mobile device) to “check in” to a particular location, and an edge can connect the user's node with the location's node in the social graph.

The social networking system can provide a variety of communication channels to users. For example, the social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their avatar or true-to-life representation) with objects or other avatars in a virtual environment (e.g., in an artificial reality working environment), etc. In some embodiments, a user can post a status message to the user's profile indicating a current event, state of mind, thought, feeling, activity, or any other present-time relevant communication. The social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment where users can communicate and interact via avatars or other digital representations of themselves. Further, the first user can comment on the profile page of a second user or can comment on objects associated with the second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users, and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Conventional methods of phone number verification using SMS OTP codes are costly and inefficient. In addition, users often need to perform this verification for multiple apps individually, increasing the cost of verification. Existing methods do not allow sharing of verifiers across apps.

The subject disclosure provides for systems and methods for registration and verification on user applications. A user is allowed to register for multiple user applications without having to verify their phone number through an SMS OTP code. For example, the user can register for the multiple user applications using a query and encryption protocol exchange between one of the user applications, its web client, and its application server.

Implementations described herein address the aforementioned shortcomings and other shortcomings by providing a feature to enable sharing of verifiers across multiple apps, thereby reducing the cost and increasing the efficiency of verification. For example, some implementations may provide sharable verifiers between multiple apps based on verified OTP codes.

Some implementations aim to reduce user phone number verification costs for multiple user applications, such as social media and instant messaging platforms. For example, a messaging app may provide features like messaging, voice and video calls, media sharing, and more. A messaging service server may run the messaging service and may be responsible for storing user data, managing message and media delivery, and providing other messaging app features. A configuration file may be used by messaging app servers to configure various settings for each client that connects to the messaging service. A table may include information such as the capabilities of the client, its device type, and other relevant data. Multi-app auto-configuration may allow multiple messaging app clients to share the same messaging service account, useful for users who want to access their messaging services account on multiple devices without logging in and out of each device. Some implementations may allow users to use the messaging service without having to verify their phone number, useful for maintaining privacy or anonymity. Some implementations may allow users to opt-out of sharing their data with third parties, useful for users who are concerned about their privacy.

The messaging app may query supported client capabilities (attributes and protocols) to an application web client, which may return encrypted client capabilities, including the supported attributes and encryption protocols available on the device. For example, client capabilities may include a set of features and functionalities that a particular messaging service client can perform, determined based on the version of the messaging service client, the device it is installed on, and other factors. The messaging app may make a call to a gateway API with the client capabilities to start registration. The server may look up all verifiers stored with the user's phone number and return the most recent verifier stored. If no relevant verifiers are found, the messaging service server may query the application web server for available verifiers for the user's phone number by providing the phone number (encrypted or unencrypted), the client capabilities, and messaging service's most recent verifier, if any. If no eligible verifiers are found, the client proceeds with the original OTP verification.

The messaging service server may send the code to the user's phone via SMS/Voice/Flash, and the user inputs the OTP code/intercepted flash call number. The user's guessed OTP code is verified as matching what is stored on the server and returns the registration success response. An appropriate auto-confirmation type may be returned to the messaging app based on the user's current auto-configuration consent status. If the client is eligible for multi-app auto-confirmation, but no consent is provided, the client may need to ask for user consent before creating shareable verifiers. The messaging app may decide whether to show the notification message to the user based on the response.

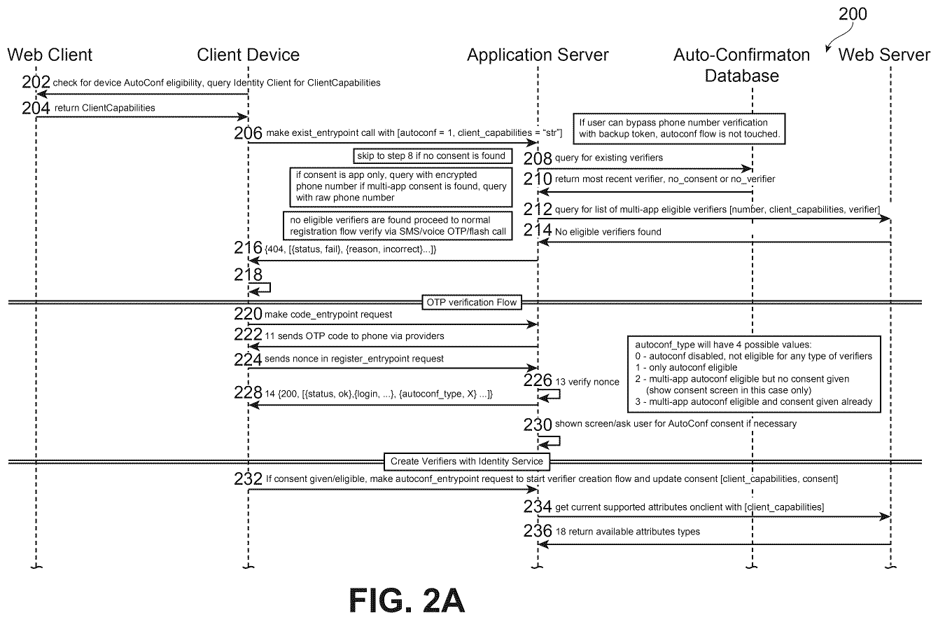

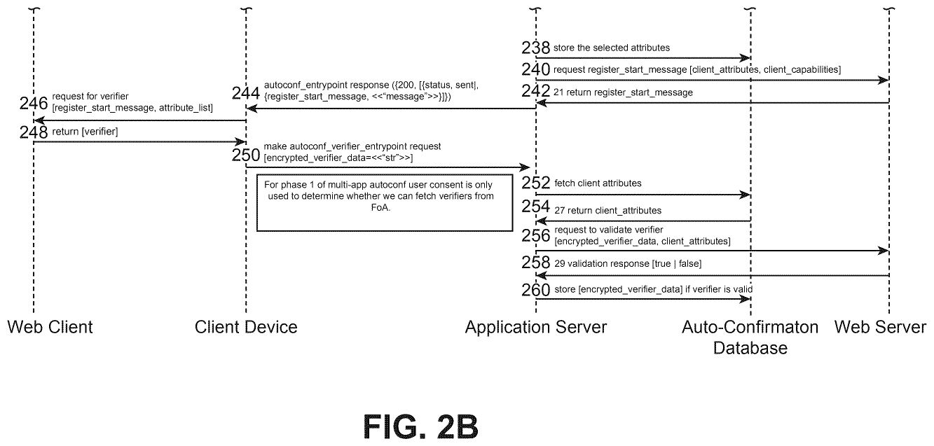

FIGS. 2A and 2B illustrate an example flow diagram (e.g., process 200) for registration through user applications, in accordance with one or more implementations. For explanatory purposes, the steps of the example process 200 are described herein as occurring in serial, or linearly. However, multiple instances of the example process 200 may occur in parallel. In step 202, client device queries supported client capabilities from the web client to begin the registration flow for user phone number verification. In step 204, the web client returns client capabilities, which contains supported attributes and encryption protocols available on the device, to client device. Step 206 involves client device starting registration by making a gateway API (exist_entrypoint) call to the application server (reg2d) with the client capabilities.

In step 208, application server looks up the auto-confirmation database for all verifiers stored with the user's phone number, keeping only the most recent verifier. In step 210, the auto-confirmation database returns the most recent verifier stored for the user's phone number or no verifier (no_verifier) if no relevant verifiers are found. If the user has not consented to multi-app auto-confirmation, no consent (no_consent) is returned instead. Step 212 involves application server querying web server for available verifiers for the user's phone number by providing the phone number (encrypted or unencrypted), the client capabilities, and the user application's most recent verifier, if any. The server queries with an encrypted phone number if the consent is for the user application only and with a raw phone number if the consent is for multi-app.

In step 214, web server returns to application server that no eligible verifiers are found, proceeding to registration steps. Step 216 involves application server returning the 404 incorrect response to client device, which allows the client to proceed with the original OTP verification. In step 218, client device checks that no server start message (server_start_message) is returned. This means that the server did not find a verifier to use, and Android should proceed to the regular OTP registration flow. In step 220, client device makes the code entry point (code_entrypoint) call to request an OTP code/flash call.

Step 222 involves application server sending the OTP code to the user's phone via SMS/Voice/Flash. In step 224, client device makes the register entry point (register_entrypoint) call to supply the user-inputted OTP code/intercepted flash call number. In step 226, application server verifies that the user's guessed OTP code matches what is stored on the server. In step 228, application server returns the registration success response to client device. The response contains the user's current auto-confirmation consent status and the appropriate auto-confirmation type (autoconf_type).

Step 230 involves client device deciding whether to show the new consent screen to users based on auto-confirmation type field returned from the server in step 228. If auto-confirmation type is 0, not eligible for either, no consent screen is shown. If auto-confirmation type is 1, only eligible for intra-app, no consent screen is shown. If auto-confirmation type is 2 and the user didn't give consent, the consent screen is displayed. If the user does NOT give consent, proceed to step 232, keeping the consent as the user application. If the user gives consent, set consent as multiple user applications. If auto-confirmation type is 3 and the user already gave multi-app consent, no consent screen is displayed.

In step 232, client device starts verifier creation by making a request to the gateway API (autoconf_entrypoint), providing the client capabilities and user consent (e.g., single or multiple user applications). In step 234, application server gets the current supported attributes on the client by providing the client capabilities. In step 236, web server returns the available list of attributes on the device to application server. In step 238, application server stores the available list of client attributes in the auto-confirmation database. In step 240, application server starts the registration flow for selected attribute(s) by generating an encrypted key pair and sending the public key to the web server along with the attribute(s) selected by the client. In step 242, the web server generates an attestation certificate for the client's device using the available attestation key and returns it to application server. In step 244, application server verifies the attestation certificate using the web attestation public key and the stored root attestation certificate.

In step 246, if the attestation certificate is successfully verified, application server sends a registration request to the web server (e.g., through the client device) containing the client's public key and the selected attribute(s). In step 248, web server validates the registration request and creates a new verifier for the client, which is then returned to application server in step 250. In step 250, application server stores the verifier in the auto-confirmation database.

The registration flow is now complete, and the client can use the selected attribute(s) for authentication purposes. In steps 250-260, when the client wants to authenticate using the registered attribute(s), it sends an authentication request to application server containing the attribute(s) and the verifier. The application server forwards the request to the web server, which verifies the attestation certificate and the signature using the verifier.

If the verification is successful, web server returns a signed authentication token to application server, which in turn returns it to the client. The client can then use the authentication token to authenticate itself to the server. The registration and authentication process for client attributes involves multiple steps and multiple servers working together to ensure the security of the process. By leveraging attestation certificates and verifiers, the system can prevent unauthorized access and protect the client's sensitive data.

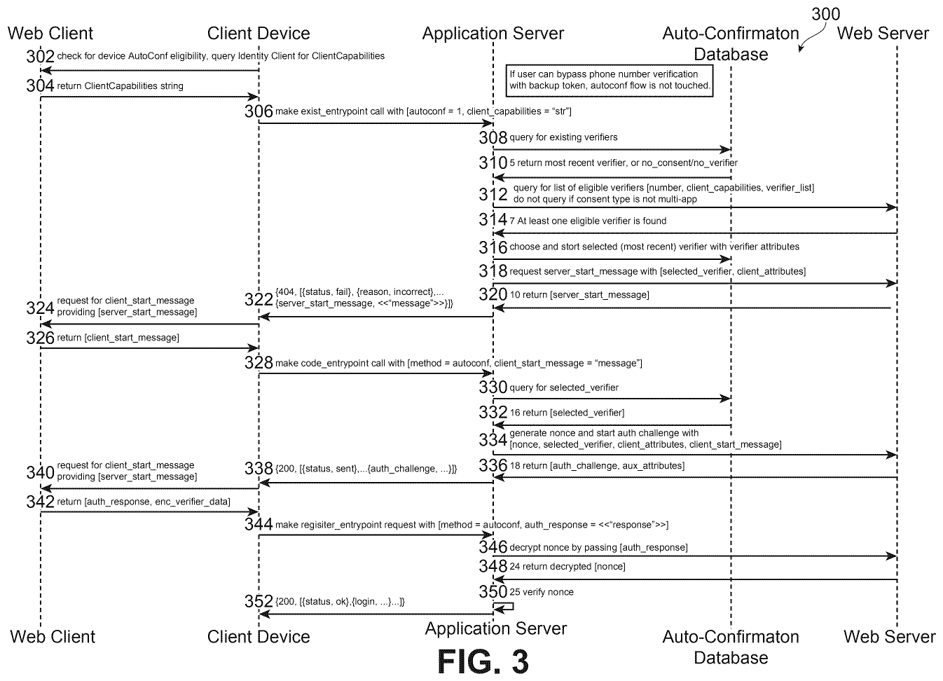

FIG. 3 illustrates an example flow diagram (e.g., process 300) for verification through user applications, in accordance with one or more implementations. For explanatory purposes, the steps of the example process 300 are described herein as occurring in serial, or linearly. However, multiple instances of the example process 300 may occur in parallel. In step 302, the client device starts the registration process by querying the supported client capabilities, which includes the attributes and protocols available on the device. In step 304, the web client responds to the query from the client device by returning the client capabilities, which is an encrypted message that can be decrypted on the server.

In step 306, the client device starts the registration by making the gateway API (exist_entrypoint) call to the application server (reg2d) with the client capabilities. In step 308, the application server looks up the auto-confirmation database for all verifiers stored with the user's phone number. The auto-confirmation database returns the most recent verifier stored for the user's phone number or returns no consent (no_consent) if the user has not consented to multi-app auto-confirmation or no verifier (no_verifier) if no relevant verifiers are found.

In step 310, the application server queries for the available verifiers for the user's phone number by providing the phone number (encrypted or unencrypted), the client capabilities, and the user application's most recent verifier, if any, to the web server. If consent is the user application only, the query is made with the encrypted phone number. If consent is multi-app, even if the user application has no verifier stored, the query is made with the raw phone number. In step 312, the web server responds to the application server that at least one eligible verifier is found.

In step 314, the application server selects one verifier and stores the selected verifier (selected_verifier) in the auto-confirmation database. In step 316, the application server starts the authentication flow by providing the selected verifier and client attributes to the web server. In step 318, the web server returns the server start message (ServerStartMessage) to the application server. In step 320, the application server returns a 404 incorrect response plus server start message (server_start_message) to the client device.

In step 322, the client device starts the authentication flow by providing the server start message (ServerStartMessage) to the web client. In step 324, the web client responds to the client device by returning the client start message (ClientStartMessage), which includes information required for creating a shared secret with the web server to be used in the client as part of the challenge decryption. In step 326, the client device makes the gateway API (code_entrypoint) call with a method equal to auto-confirmation to the application server and provides the client start message (client_start_message).

In step 328, the application server looks up the auto-confirmation database for the selected verifier. In step 330, the auto-confirmation database returns the selected verifier information to the application server. In step 332, the application server generates and stores a nonce and requests an auth challenge from the web server, providing the nonce, selected verifier, client attributes, and client start message (client_start_message). In step 334, the web server returns the authorization challenge (auth_challenge) and a list of auxiliary attributes, if any.

In step 336, the application server returns the 200 sent response, relaying authorization challenge (auth_challenge) to the client device. In step 338, the client device authenticates the challenge and sends the encrypted response (AuthResponse) and a new potential verifier to the web client. In step 340, the web client returns the encrypted response (AuthResponse) and the new potential verifier to the client device. In step 342, the client device makes the gateway API (register_entrypoint) call with method equal to auto-confirmation to the application server, providing the encrypted authorization response (auth_response). The authorization response (auth_response) is decrypted by the application server in step 344. The decrypted response is sent to the web server in step 346, which decrypts the response and returns the raw nonce in step 348.

In step 350, the application server verifies if the raw nonce received in step 348 matches the correct OTP code. If the raw nonce matches the correct OTP code, then the application server sends the 200 success response to the client device in step 352. If the raw nonce does not match the correct OTP code, then the application server sends a failure response to the client device. The client device receives the response from the application server. If the response is a success response, then the client device completes the registration process and logs in to the user application. If the response is a failure response, then the client device returns an error message to the user.

The verification through user applications process described above can be implemented using software running on computing devices such as servers, smartphones, tablets, and the like. The process can be implemented using any suitable programming language and can be executed using any suitable computing system. The process can be used to verify a user's phone number for any application that requires phone number verification, including messaging applications, social networking applications, and the like. It should be understood that the flow diagrams illustrated in FIGS. 2A, 2B, and 3 is for illustrative purposes only, and that some implementations may include additional or different steps than those shown in the flow diagram. Additionally, the steps shown in the flow diagram may be performed in a different order than shown, or may be performed simultaneously or in parallel with other steps.

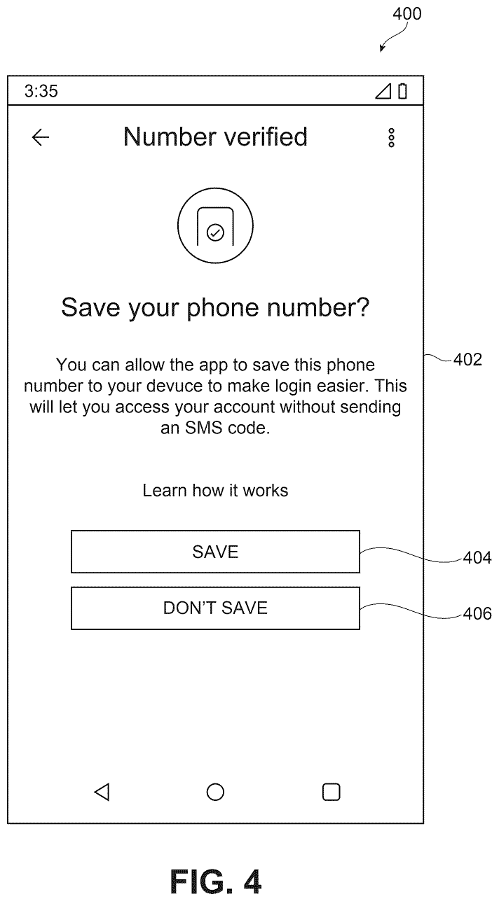

FIG. 4 illustrates an example view 400 of a user application during verification, in accordance with one or more implementations. The view 400 includes a prompt 402 asking whether the user wants the user application to save their phone number on the device, a save button 404, a don't save button 406, and/or other components. The prompt 402 may be a pop-up window that appears when the user starts the verification process. The prompt 402 may ask whether the user wants the user application to save their phone number on the device for future use. The save button 404 may be a button that the user can select to save their phone number on the device. The don't save button 406 may be a button that the user can select if they do not want the user application to save their phone number on the device.

In some implementations, if the user selects the save button 404, the user application may save the user's phone number on the device. This may allow the user application to automatically fill in the user's phone number in future verification processes. If the user selects the don't save button 406, the user application may not save the user's phone number on the device.

In some implementations, the prompt 402 may include a checkbox or toggle button that allows the user to opt-in or opt-out of future verifications for other applications in the same family of apps. The checkbox or toggle button may be labeled as “Share my phone number with other apps in the family” or a similar phrase. If the user selects this checkbox or toggle button, the user application may share the user's phone number with other apps in the same family for future verifications, which may reduce the need for SMS OTP codes and save verification costs. In some implementations, the view 400 may be displayed in a different format or style. For example, the prompt 402, save button 404, and don't save button 406 may be displayed as separate pages or screens instead of a pop-up window. The checkbox or toggle button for opting-in or opting-out of future verifications may be displayed in a different location or format, such as a drop-down menu or slider button. In some implementations, the view 400 may be modified or customized based on the user's device or operating system. For example, the view 400 may use different colors, fonts, or icons depending on the device or operating system. The view 400 may also be modified to comply with different regulations or laws in different regions or countries.

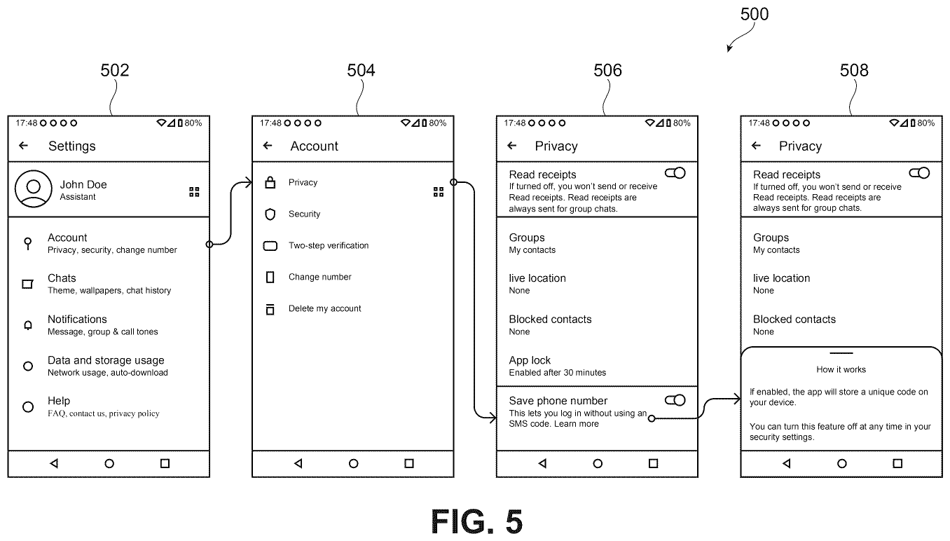

FIG. 5 illustrates example views 500 of the user application during privacy setting updates, in accordance with one or more implementations. The views 500 may include a settings screen 502, an account screen 504, a privacy screen 506, an explanation screen 508, and/or other components. In some implementations, the settings screen 502 may allow users to manage various app settings, including privacy settings. In some implementations, the settings screen 502 may allow users to access additional privacy settings. For example, the settings screen 502 may allow users to control who can see their status updates, profile picture, or last seen status. The settings screen 502 may also allow users to manage their chat history, such as deleting messages or archiving chats.

The account screen 504 may display information related to the user's account, such as their name, profile picture, and contact information. In some implementations, the account screen 504 may display the user's current multi-app auto-configuration feature consent status. The account screen 504 may indicate whether the user has given consent for multi-app auto-configuration feature and whether they are eligible for the feature. The account screen 504 may also provide users with the option to change their multi-app auto-configuration feature consent status.

The privacy screen 506 may allow users to adjust their privacy preferences for the app. In some implementations, the privacy screen 506 may include options for enabling or disabling the multi-app auto-configuration feature. The privacy screen 506 may also include a toggle switch for turning the multi-app auto-configuration feature on or off. When the toggle switch is turned off, the user's phone number information may not be shared with other applications. In some implementations, the privacy screen 506 may allow users to adjust their privacy settings for specific contacts or groups. For example, the privacy screen 506 may allow users to block or mute specific contacts or groups. The privacy screen 506 may also allow users to control who can add them to groups or see their profile information.

In some implementations, the explanation screen 508 may provide users with more information about the multi-app auto-configuration feature. The explanation screen 508 may describe the benefits of the multi-app auto-configuration feature, such as user convenience or reduced SMS verification costs. The explanation screen 508 may also describe how the multi-app auto-configuration feature works and how it may impact the user's privacy. The views 500 may allow users to control who can access their phone number information and ensure that their privacy preferences are respected. The views 500 may also provide users with more information about the multi-app auto-configuration feature and help them make informed decisions about their privacy.

The disclosed system(s) address a problem in traditional user application registration and verification techniques tied to computer technology, namely, the technical problem of security vulnerabilities and identity theft resulting from weak authentication methods and lack of robust verification processes. The disclosed system solves this technical problem by providing a solution also rooted in computer technology, namely, by providing for multi-application registration and verification. The disclosed subject technology further provides improvements to the functioning of the computer itself because it improves processing and efficiency in registration and verification on user applications.

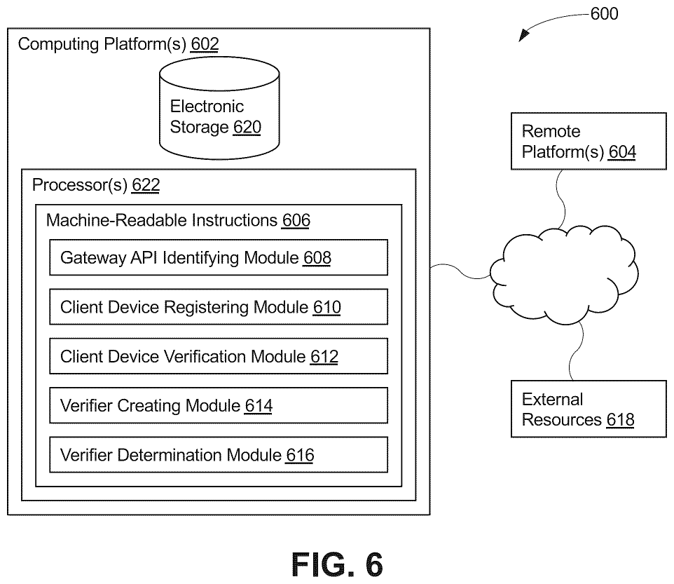

FIG. 6 illustrates a system 600 configured for registration and verification on user applications, according to certain aspects of the disclosure. In some implementations, system 600 may include one or more computing platforms 602. Computing platform(s) 602 may be configured to communicate with one or more remote platforms 604 according to a client/server architecture, a peer-to-peer architecture, and/or other architectures. Remote platform(s) 604 may be configured to communicate with other remote platforms via computing platform(s) 602 and/or according to a client/server architecture, a peer-to-peer architecture, and/or other architectures. Users may access system 600 via remote platform(s) 604.

Computing platform(s) 602 may be configured by machine-readable instructions 606. Machine-readable instructions 606 may include one or more instruction modules. The instruction modules may include computer program modules. The instruction modules may include one or more of gateway API identifying module 608, client device registering module 610, client device verification module 612, verifier creating module 614, verifier determination module 616, and/or other instruction modules.

Gateway API identifying module 608 may be configured to identify a gateway API on a client device. In some implementations, the gateway API may be configured to communicate with a plurality of auxiliary application program interfaces accessible on the client device via at least one verifier. The auxiliary application program interface can comprise a social media platform. In some implementations, the at least one verifier may include a plurality of verifiers. In some implementations, each verifier is configured to communicate with a different social media platform. In some implementations, the at least one verifier may include a primary verifier and a secondary verifier. In some implementations, the primary verifier may be configured to communicate with a first social media platform and the secondary verifier is configured to communicate with a second social media platform.

In some implementations, the verifier may be associated with a specific user account. In some implementations, the verification process may further include verifying a user's identity via biometric authentication. In some implementations, the verifier may be communicated with a third-party authentication service. In some implementations, the at least one verifier may be selected based on a user's consent for multi-app auto-confirmation. In some implementations, the at least one verifier may be selected based on a user's preference for a specific social media platform. In some implementations, the at least one verifier may be selected based on a specific time of day. In some implementations, the at least one verifier may be shared between different user accounts associated with the same client device. In some implementations, the at least one verifier may be configured to communicate with a plurality of messaging applications on the client device.

Client device registering module 610 may be configured to register the client device via the gateway API. The client device may be registered with the gateway API by providing an email address associated with the client device.

Client device verification module 612 may be configured to verify registration of the client device. Verifying registration may include identifying at least one verifier associated with a phone number associated with the client device. Verifying registration may include transmitting an OTP to the client device. The OTP code may include a short message service message. The verification process may include comparing a received OTP code to a stored OTP code associated with the client device. Verifying registration may include transmitting an email message to the email address provided during registration. The verification process may include verifying a digital signature associated with the client device. The verification process may be repeated periodically to ensure continued authentication of the client device. The verification process may be initiated by the client device rather than the server. A verification status of the client device may be shared with at least one social media platform or other auxiliary application program interface associated with the client device.

Verifier creating module 614 may be configured to create at least one verifier configured to communicate between a plurality of social media platforms. The at least one verifier may be selected based on a geographic location of the client device. The at least one verifier may be selected based on a language setting of the client device. The verifier may be configured to authenticate the client device based on a challenge-response protocol.

Verifier determination module 616 may be configured to determine a preexisting verifier for the client device. One or both of a registration or a verification status of the client device may be synchronized across multiple social media platforms or other auxiliary application program interfaces. Verifier determination module 616 may be configured to determine that the preexisting verifier has exceeded a registration threshold. The registration threshold may be at least 30 days. A unique identifier (e.g., verifier) may be generated for the client device upon successful registration and verification. The unique identifier may be a verifier used for subsequent authentication of the client device with the gateway API and other auxiliary application program interfaces (social media platforms). This unique identifier (verifier) can be created by sorting and then concatenating unique device attributes (some of which can be device-dependent and/or hardware backed) in a stable manner with a randomly generate sequence. The concatenated sequence can then be encrypted. Further, the unique identifier is generate using unique device attributes which are device dependent and then concatenated with a random sequence.

In some implementations, computing platform(s) 602, remote platform(s) 604, and/or external resources 618 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 602, remote platform(s) 604, and/or external resources 618 may be operatively linked via some other communication media.

A given remote platform 604 may include one or more processors configured to execute computer program modules. The computer program modules may be configured to enable an expert or user associated with the given remote platform 604 to interface with system 600 and/or external resources 618, and/or provide other functionality attributed herein to remote platform(s) 604. By way of non-limiting example, a given remote platform 604 and/or a given computing platform 602 may include one or more of a server, a desktop computer, a laptop computer, a handheld computer, a tablet computing platform, a NetBook, a Smartphone, a gaming console, and/or other computing platforms.

External resources 618 may include sources of information outside of system 600, external entities participating with system 600, and/or other resources. In some implementations, some or all of the functionality attributed herein to external resources 618 may be provided by resources included in system 600.

Computing platform(s) 602 may include electronic storage 620, one or more processors 622, and/or other components. Computing platform(s) 602 may include communication lines, or ports to enable the exchange of information with a network and/or other computing platforms. Illustration of computing platform(s) 602 in FIG. 6 is not intended to be limiting. Computing platform(s) 602 may include a plurality of hardware, software, and/or firmware components operating together to provide the functionality attributed herein to computing platform(s) 602. For example, computing platform(s) 602 may be implemented by a cloud of computing platforms operating together as computing platform(s) 602.

Electronic storage 620 may comprise non-transitory storage media that electronically stores information. The electronic storage media of electronic storage 620 may include one or both of system storage that is provided integrally (i.e., substantially non-removable) with computing platform(s) 602 and/or removable storage that is removably connectable to computing platform(s) 602 via, for example, a port (e.g., a USB port, a firewire port, etc.) or a drive (e.g., a disk drive, etc.). Electronic storage 620 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 620 may include one or more virtual storage resources (e.g., cloud storage, a virtual private network, and/or other virtual storage resources). Electronic storage 620 may store software algorithms, information determined by processor(s) 622, information received from computing platform(s) 602, information received from remote platform(s) 604, and/or other information that enables computing platform(s) 602 to function as described herein.

Processor(s) 622 may be configured to provide information processing capabilities in computing platform(s) 602. As such, processor(s) 622 may include one or more of a digital processor, an analog processor, a digital circuit designed to process information, an analog circuit designed to process information, a state machine, and/or other mechanisms for electronically processing information. Although processor(s) 622 is shown in FIG. 6 as a single entity, this is for illustrative purposes only. In some implementations, processor(s) 622 may include a plurality of processing units. These processing units may be physically located within the same device, or processor(s) 622 may represent processing functionality of a plurality of devices operating in coordination. Processor(s) 622 may be configured to execute modules 608, 610, 612, 614, and/or 616, and/or other modules. Processor(s) 622 may be configured to execute modules 608, 610, 612, 614, and/or 616, and/or other modules by software; hardware; firmware; some combination of software, hardware, and/or firmware; and/or other mechanisms for configuring processing capabilities on processor(s) 622. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 608, 610, 612, 614, and/or 616 are illustrated in FIG. 6 as being implemented within a single processing unit, in implementations in which processor(s) 622 includes multiple processing units, one or more of modules 608, 610, 612, 614, and/or 616 may be implemented remotely from the other modules. The description of the functionality provided by the different modules 608, 610, 612, 614, and/or 616 described below is for illustrative purposes, and is not intended to be limiting, as any of modules 608, 610, 612, 614, and/or 616 may provide more or less functionality than is described. For example, one or more of modules 608, 610, 612, 614, and/or 616 may be eliminated, and some or all of its functionality may be provided by other ones of modules 608, 610, 612, 614, and/or 616. As another example, processor(s) 622 may be configured to execute one or more additional modules that may perform some or all of the functionality attributed below to one of modules 608, 610, 612, 614, and/or 616.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

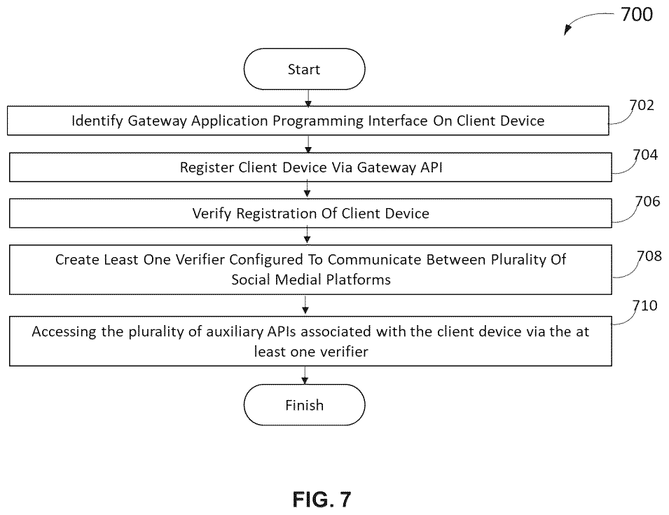

FIG. 7 illustrates an example flow diagram (e.g., process 700) for registration and verification on user applications, according to certain aspects of the disclosure. For explanatory purposes, the example process 700 is described herein with reference to FIGS. 1-6. Further for explanatory purposes, the steps of the example process 700 are described herein as occurring in serial, or linearly. However, multiple instances of the example process 700 may occur in parallel. For purposes of explanation of the subject technology, the process 700 will be discussed in reference to FIGS. 1-6.

At step 702, the process 700 may include identifying a gateway API on a client device. At step 704, the process 700 may include registering the client device via the gateway API. At step 706, the process 700 may include verifying registration of the client device. At step 708, the process 700 may include creating at least one verifier configured to communicate between a plurality of social media platforms.

For example, as described above in relation to FIG. 6, at step 702, the process 700 may include identifying a gateway API on a client device, through gateway API identifying module 608. The gateway API may be configured to communicate with a plurality of auxiliary APIs associated with the client device. At step 704, the process 700 may include registering the client device via the gateway API, through client device registering module 610. At step 706, the process 700 may include verifying registration of the client device, through client device verification module 612. At step 708, the process 700 may include creating at least one verifier configured to communicate between a plurality of social media platforms, through verifier creating module 614. At step 710, the process 700 may access the plurality of auxiliary APIs associated with the client device via the verifier through gateway API identifying module 608. In another embodiment, an API access module (not shown) can be configured to use the verifier to provide access to the auxiliary APIs.

According to an aspect, the gateway API is configured to communicate with a plurality of social media platforms accessible on the client device via the at least one verifier.

According to an aspect, verifying registration comprises identifying at least one verifier associated with a phone number associated with the client device and transmitting a one-time password code to the client device.

According to an aspect, the OTP code comprises a short message service message.

According to an aspect, the process 700 may include determining a preexisting verifier for the client device.

According to an aspect, the process 700 may include determining that the preexisting verifier has exceeded a registration threshold.

According to an aspect, the registration threshold is at least 30 days.

According to an aspect, the at least one verifier comprises a plurality of verifiers, each verifier configured to communicate with a different social media platform.

According to an aspect, the at least one verifier comprises a primary verifier and a secondary verifier, wherein the primary verifier is configured to communicate with a first social media platform and the secondary verifier is configured to communicate with a second social media platform.

According to an aspect, the verifier is associated with a specific user account on the social media platform.

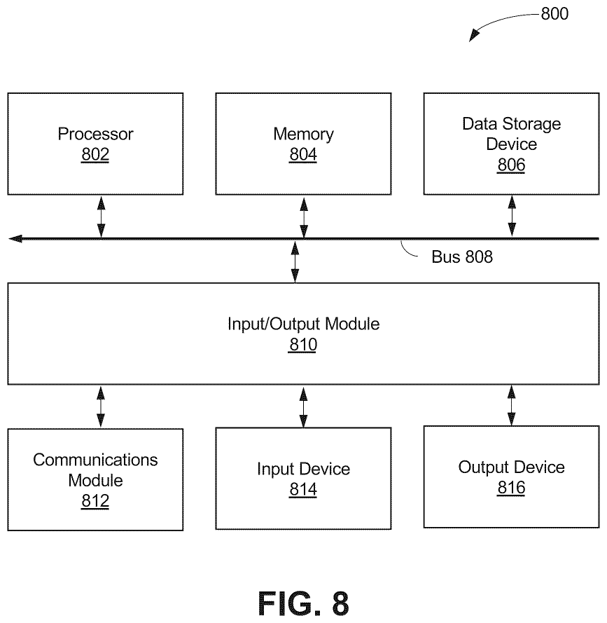

FIG. 8 is a block diagram illustrating an exemplary computer system 800 with which aspects of the subject technology can be implemented. In certain aspects, the computer system 800 may be implemented using hardware or a combination of software and hardware, either in a dedicated server, integrated into another entity, or distributed across multiple entities.

Computer system 800 (e.g., server and/or client) includes a bus 808 or other communication mechanism for communicating information, and a processor 802 coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, i.e., one or more modules of computer program instructions encoded on a computer-readable medium for execution by, or to control the operation of, the computer system 800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. The input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, the input/output module 810 is configured to connect to a plurality of devices, such as an input device 814 and/or an output device 816. Exemplary input devices 814 include a keyboard and a pointing device, e.g., a mouse or a trackball, by which a user can provide input to the computer system 800. Other kinds of input devices 814 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 816 include display devices such as an LCD (liquid crystal display) monitor, for displaying information to the user.

According to one aspect of the present disclosure, the above-described gaming systems can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in the main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires that comprise bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 800 reads game data and provides a game, information may be read from the game data and stored in a memory device, such as the memory 804. Additionally, data from the memory 804 servers accessed via a network the bus 808, or the data storage 806 may be read and loaded into the memory 804. Although data is described as being found in the memory 804, it will be understood that data does not have to be stored in the memory 804 and may be stored in other memory accessible to the processor 802 or distributed among several media, such as the data storage 806.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method for multi-application registration and verification, the method comprising:
identifying a gateway application programming interface (API) on a client device, wherein the gateway API is configured to communicate with a plurality of auxiliary APIs associated with the client device;
registering the client device via the gateway API;
verifying registration of the client device;
creating at least one verifier configured to communicate between the plurality of auxiliary APIs associated with the client device; and
accessing the plurality of auxiliary APIs associated with the client device via the at least one verifier.

2. The method of claim 1, wherein the auxiliary APIs associated with the client device comprise a social media platform.

3. The method of claim 1, wherein verifying registration comprises:
identifying at least one verifier associated with a phone number associated with the client device; and
transmitting a one-time password code to the client device.

4. The method of claim 3, wherein the one-time password (OTP) code comprises a short message service message (SMS).

5. The method of claim 1, further comprising determining a preexisting verifier for the client device.

6. The method of claim 5, further comprising determining that the preexisting verifier has exceeded a registration threshold.

7. The method of claim 6, wherein the registration threshold is at least 30 days.

8. The method of claim 1, wherein the at least one verifier comprises a plurality of verifiers, each verifier configured to communicate with a different API.

9. The method of claim 1, wherein the at least one verifier comprises a primary verifier and a secondary verifier, wherein the primary verifier is configured to communicate with a first social media platform and the secondary verifier is configured to communicate with a second social media platform.

10. The method of claim 1, wherein the verifier is associated with a specific user account.

11. A system configured for multi-application registration and verification, the system comprising:
one or more hardware processors configured by machine-readable instructions to:
identify a gateway application programming interface (API) on a client device, wherein the gateway API is configured to communicate with a plurality of auxiliary APIs associated with the client device;
register the client device via the gateway API;
verify registration of the client device;
determine a preexisting verifier for the client device;
determine that the preexisting verifier has exceeded a registration threshold; and
create at least one verifier configured to communicate between a plurality of auxiliary APIs.

12. The system of claim 11, wherein verifying registration comprises comparing a received OTP code to a stored OTP code associated with the client device.

13. The system of claim 11, wherein verifying registration comprises verifying a digital signature associated with the client device.

14. The system of claim 11, wherein the at least one verifier is selected based on a geographic location of the client device.

15. The system of claim 11, wherein the at least one verifier is selected based on a language setting of the client device.

16. The system of claim 11, wherein verifying registration further comprises verifying a user's identity via biometric authentication.

17. The system of claim 11, wherein the verifier is communicated with a third-party authentication service.

18. The system of claim 11, wherein the at least one verifier is selected based on a user's consent for multi-app auto-confirmation.

19. The system of claim 11, wherein the at least one verifier is selected based on a user's preference for a specific auxiliary API, wherein the auxiliary API comprises a social media platform.

20. A non-transient computer-readable storage medium having instructions embodied thereon, the instructions being executable by one or more processors to perform a method for multi-application registration and verification, the method comprising:
identifying a gateway application programming interface (API) on a client device, wherein the gateway API is configured to communicate with a plurality of auxiliary APIs associated with the client device;
registering the client device via the gateway API;
verifying registration of the client device, wherein verifying registration further comprises verifying a user's identity via biometric authentication;
determining a preexisting verifier for the client device;
determining that the preexisting verifier has exceeded a registration threshold; and
creating at least one verifier configured to communicate between a plurality of auxiliary APIs associated with the client device, wherein at least one verifier is selected based on a user's consent for multi-app auto-confirmation.
